(19) United States
(12) Patent Application Publication
(10) Pub. No.: US 2024/0399502 A1
(43) Pub. Date: Dec. 5, 2024

(54) LASER CLADDING METHOD FOR PRODUCING A COATING LAYER ON A COMPONENT

(71) Applicant: TRUMPF Laser- und Systemtechnik GmbH, Ditzingen (DE)

(72) Inventors: Tim Hesse, Ditzingen (DE); Nicolai Speker, Pleidelsheim (DE); Bjoern Sautter, Leonberg (DE); Andreas Scholz, Taunusstein (DE)

(21) Appl. No.: 18/806,734

(22) Filed: Aug. 16, 2024

Related U.S. Application Data
(63) Continuation of application No. PCT/EP2023/053674, filed on Feb. 14, 2023.

(30) Foreign Application Priority Data
Feb. 22, 2022 (DE) 10 2022 104 104.2

(51) Int. Cl. B23K 26/342

(52) U.S. Cl. CPC B23K 26/342

(57) ABSTRACT

A laser cladding method for producing a coating layer on a surface of a component includes applying a filler material along a helical or spiral-shaped processing trajectory on the surface of the component, and heating the filler material and the component along the processing trajectory by using a laser beam, so that when the filler material strikes the surface, least one coating track is created on the surface having a specified track width. At least two turns of the at least one coating track at least partially overlap with one another along the track width.

### CROSS REFERENCE TO RELATED APPLICATIONS

This application is a continuation of International Application No. PCT/EP2023/053674 (WO 2023/161088 A1), filed on Feb. 14, 2023, and claims benefit to German Patent Application No. DE 10 2022 104 104.2, filed on Feb. 22, 2022. The aforementioned applications are hereby incorporated by reference herein.

### FIELD

Embodiments of the present invention relate to a laser cladding method for producing a coating layer on a surface of a component, to a device for executing the laser cladding method, and to a component having at least one surface coated with a coating layer, wherein the coating layer has been produced by means of the laser cladding method.

### BACKGROUND

Conventional laser cladding is well known from the prior art. In this case, a surface of a component is melted by means of a laser beam and the melt pool formed in this case is supplied with a powdered filler material. The powder is then likewise melted in the melt pool, such that, after solidification of the molten powder material and the surface, a cohesively bonded, in particular metallurgically bonded, material layer is formed.

This procedure, depending on the application, can be conducted at different points on the surface or else over a larger coherent region of the workpiece surface, which allows 3D shapes to be applied by laser cladding. In addition, it is also possible to build up multiple material layers of different materials one on top of another on the surface. If metallic material is being applied, the cladding method is also referred to as laser metal deposition (LMD for short). Typical fields of use for laser cladding can be found in the field of repair, coating, and bonding techniques.

So-called extreme high-speed laser application (EHLA for short) is already known from DE 10 2011 100 456 B4. According to this method, a significant increase in the achievable processing speed in comparison to conventional laser cladding is achieved in that at least one filler material in at least partially molten form is supplied to a process zone present on a surface to be processed. For this purpose, the filler material, which is at first in particular in powdered form, is melted by means of a laser beam at a distance from a melt pool in particular of greater than zero and then supplied to the melt pool in completely liquid form in particular. It is possible here for the filler material, in particular the powder, to be melted at the stated distance from the melt pool and for the melt pool to be heated by the same laser beam. The laser beam incident on the melt pool thus also causes the filler material to melt at the stated distance from the melt pool. This is accomplished by moving the melt pool and a focus of the laser beam parallel to one another relative to the surface at a speed of at least 20 m/min. Furthermore, in the case of a powdered filler material, the powder density can be set in particular such that a laser power output of the laser beam in the melt pool is less than 60% of the laser power output before contact of the laser beam with the powder. It is thus possible by means of the EHLA method to significantly increase the processing speed of the laser cladding procedure.

A buildup of the coating layer, which can moreover also take place on opposite surfaces of the component, in the range of 50 μm to 500 μm, preferably around 100 μm to 200 μm layer thickness, can in particular be produced by passing multiple times over a track width of tracks of the melt pool. Higher and higher laser output powers are being used in industrial research and development to increase the productivity (cladded surface area per unit of time), for example, laser output powers up to 24 KW in a focal point. With the increase of the laser output power, the coating spot size (laser focus diameter and powder focus diameter) has to be or will be enlarged. More surface area per unit of time can be processed on the processing trajectory. Surprisingly, experimental practice has shown that the surface waviness of the layers welded by means of high-speed LMD increases as the irradiation spot diameter or laser output power becomes greater. As a result, a greater allowance of the layer thickness has to be provided so that the coating layer has the desired surface finish (inter alia, roughness) after the subsequent grinding. The coating layer has to be ground down here to the produced valleys of the wavy coating layer.

### SUMMARY

Embodiments of the present invention provide a laser cladding method for producing a coating layer on a surface of a component. The method includes applying a filler material along a helical or spiral-shaped processing trajectory on the surface of the component, and heating the filler material and the component along the processing trajectory by using a laser beam, so that when the filler material strikes the surface, least one coating track is created on the surface having a specified track width. At least two turns of the at least one coating track at least partially overlap with one another along the track width.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a setup of a device for a laser cladding method according to some embodiments;

FIG. 2 shows a top view of a component according to an exemplary embodiment of the invention;

FIG. 3 shows a top view of a component during the coating by a laser cladding method according to one exemplary embodiment of the invention;

FIGS. 4a and 4b show schematic views of the laser cladding method according to one exemplary embodiment of the invention;

FIGS. 5 and 6 show cross-sectional views of a part of the component during the coating by different laser cladding methods, according to some embodiments;

FIGS. 7 and 8 show top views of a part of the component during the coating by the different laser cladding methods of FIGS. 5 and 6, according to some embodiments; and

FIGS. 9, 10, 11, 12 and 13 show microsections through components which have been coated according to different laser cladding methods, according to some embodiments.

### DETAILED DESCRIPTION

Embodiments of the present invention can reduce the above disadvantages in a laser cladding method, in particular improving the produced component quality by reducing the surface waviness of the produced coating layer.

According to some embodiments, a laser cladding method for producing a coating layer on a surface of a component includes creating at least one coating track on the surface having a specified track width by applying a filler material, which is powdered in particular, along a helical or spiral-shaped processing trajectory, wherein the filler material and the component are heated along the processing trajectory by means of a laser beam, so that when the filler material strikes the surface, the at least one coating track results, wherein at least two, in particular at least three turns of the at least one coating track at least partially overlap or are created at least partially overlapping along a track width. In particular, a laser focus diameter of the laser beam can be greater than 1 mm, in particular 1.4 mm to 12 mm.

It has been shown that the surface waviness of the coating layer thus created can be effectively reduced by the laser cladding such that two, three, or more turns of the at least one coating track are in particular created adjacent to one another so that they partially overlap one another along a track width, which forms the coating layer or parts thereof due to solidification. The turns are in particular created adjacent to one another and partially overlapping one another. High laser output powers can thus advantageously be implemented, so that the productivity of the laser cladding method can be increased without reducing the quality of the produced components or requiring deep post-grinding of the coating layer. In particular, it is advantageous if at least four or more turns partially overlapping one another are created adjacent to one another along the track width on average over the entire at least one coating track for the production of the coating layer on a component. Moreover, it is in particular possible to create the entire coating layer using only a single coating track having a corresponding number of turns along the helical or spiral-shaped processing trajectory. The coating track created along the processing trajectory is insofar in particular created continuously and not interrupted. However, it is also possible to interrupt the processing and to use two or more coating tracks, wherein the coating tracks can each start on one another.

The specification of the turns at least partially overlapping one another along a track width relates to how many turns of the at least one coating track are applied per track width. In particular the number of turns per track width of the at least one coating track which are visible in the top view of the at least one coating track or the coating layer thus created is counted in particular here. It is thus not necessary for the turns partially overlapping one another to extend completely within a track width, because then the turns would completely overlap one another instead of only partially overlapping. The statement that the turns partially overlap here thus relates to the width of the overlap of the turns. In principle, the number of turns along a track width does not have to be a whole number here, but rather can also comprise parts of whole numbers. For example, 4.1 or 4.6 turns along a track width can partially overlap one another and can be arranged adjacent to one another.

While according to embodiments of the invention it is provided that turns created adjacent to one another at least partially overlap one another, it can moreover be provided that turns of the at least one coating track are created one on top of another by multiple passes over a track width, to thus produce a coating layer of a specific thickness, for example, in the range of 50 μm to 300 μm, preferably around 100 μm. In contrast to the creation adjacent to one another of the turns at least partially overlapping one another, however, the turns of the at least one coating track are not created adjacent to one another here. Instead, the track widths or turns which have already been created or traveled along are typically only passed over again after running through an entire processing trajectory.

In particular, it can be provided that further turns are created above turns in a starting and/or end region of the processing trajectory over its track width. In other words, multiple passes over a track width can take place especially in the starting and/or end region of the processing trajectory, as has been explained at the outset. This has the advantage of creating a constant coating layer thickness, for example, in brake disks as the component on the outer and/or inner circumference of the friction surface to be coated.

It can be provided that in each case at least four turns at least partially overlapping one another are created adjacent to one another along a track width. It has surprisingly been shown that from four turns partially overlapping one another, only a low surface waviness of the coating layer is still created, which insofar does not have to be subjected to postprocessing or can be postprocessed by only minor post-grinding.

It can also be provided that the turns partially overlapping one another overlap one another by at least 20%, in particular at least 40%, of the track width. In particular, the degrees of overlap, which are specified here, for example, by a percentage ratio of the track width, can be essentially equal in the turns. It has been shown that a low surface waviness of the coating layer is likewise created by these degrees of overlap.

Moreover, it can be provided that the number of turns at least partially overlapping one another along the track width is varied during the production of the processing layer. In particular, a variation of the number of the turns by up to 50% of the turns overlapping one another on average partially along a track width and/or a variation of the degree of overlap by up to 50% of the average degree of overlap over all turns can take place. This has the advantage that an adaptation of the coating layer thickness can be performed in the laser cladding process. Moreover, in a regulation operation of the laser cladding process, the coating layer thickness can be guided around a target value and in so-called shielded disks, plane-parallel surfaces of the component opposite to one another can be created via coating layer thicknesses extending in a wedge shape.

Furthermore, it can be provided that a height profile of the surface coated using the at least one coating track is generated by a measuring device. The measuring device can be configured, for example, for a light section. The measuring device can also be, for example, an optical coherence tomography or thermography measuring device. The advantage of such a measuring device is that undesired waviness of the coating layer can be monitored via the generated height profile. Moreover, the height profile or a parameter derived therefrom, which is indicative of the waviness of the coating layer, can be compared to a specified limiting value. If the specified limiting value is exceeded, an automatic stop of the production process can take place or a regulatory intervention can be performed in the laser cladding process to reduce the waviness.

It can be provided that a point of incidence of the laser beams on the surface is moved along the surface at a relative speed of at least 20 m/min. The relative speed is that speed with which the surface to be coated is moved relative to the point of incidence of the laser beam on the surface. The laser beam is incident on the surface so that a process zone arises on the surface, in particular at least partially a melt pool on the surface. Therefore, one could also say that the point of incidence and therefore the process zone arc moved along the surface at a speed of at least 20 m/min. The advantage of this high relative speed is above all the high achievable productivity. Such laser cladding can also be referred to as high-speed laser cladding.

Furthermore, it can be provided that the component is designed as rotationally symmetrical, in particular as a disk, and in particular is rotated around an axis of rotation during the production of the coating layer, in particular so that the processing trajectory follows the spiral or helix shape. The component can, for example, be a brake disk, slide disk, friction disk, or the like, as can be used in various applications, for example in motor vehicles. The surface to be coated or surfaces to be coated which are opposite to one another can each be circular ring-shaped surfaces. Accordingly, rotation of the disk around its axis of rotation permits circumferential coating of the disk. For this purpose, the disk can be secured on a shaft of a corresponding drive, for example of an electric motor, that sets the disk in rotation. Aside from this, of course, the point of incidence of the laser beam can be shifted, in particular in a linear movement. In particular, it can be shifted in a plane across the disk. This can be effectuated, for example, by a linear drive at the processing heads which emits the laser beam. The alignment of the feed of the at least one filler material can also be shifted in each case together with the point of incidence of the laser beam.

Furthermore, it can be provided that the at least one filler material is in powder form before being melted by means of the laser beam. The filler material can be metallic. As well as a metallic filler material, other materials that are to be incorporated into the coating layer can also be present. In addition, it is also possible to process different metals. Alternatively, it is conceivable that the filler material is in the form of a wire, tape, or sheet metal strip. However, the supply of powdered filler material to the laser beam for melting, such that it is supplied to the process zone in essentially fully molten form, has been found to be advantageous.

In addition, it can be provided that the at least one filler material is provided for the respective laser beam by at least three injectors for each surface of the component. Preferably, there are 3 to 21 injectors, in particular 7 to 14 injectors, per surface or side of the component. As a result, it is possible to create a very symmetric focus of the filler material, especially powder focus, on the surface, which can improve the quality of the coating layer generated.

Moreover, it can be the case that an average powder efficiency with powdered filler material from all injectors together is at least 85%. Powder efficiency indicates how much of the powder supplied is melted. Loss of powder can thus be reduced. One means by which this is enabled is the use of injectors that can be used in the angle range around 90° in relation to the direction of gravity.

Moreover, it can be the case that the injectors are supplied with powder from a corresponding powder conveyor by two or more feed lines that can be directed via a distributor component into two or more clusters by the injectors. The necessary powder mass flow rate can thus be divided between parallel powder feed strands. This achieves a uniform powder mass flow rate, and therefore uniform coating layers are created.

The injectors can advantageously be designed as tubes. In particular, they can be designed as carbide tubes in order to have high resistance, on the one hand, to the filler material and, on the other hand, to the high temperatures that originate from the processing. The advantage of tubes lies additionally in a good flow of a possible conveying gas through them, in order to supply the filler material from a corresponding conveyor or reservoir to the laser beam at a distance from the surfaces.

In addition, it can be provided that an exit angle of the injectors with respect to a perpendicular to the respective surface of the component is less than 60°, in particular less than 50°, or less than 40°. It has been found that the resulting surface waviness of the coating layer that has been welded on thereby is thus minor.

It can furthermore be provided that the at least one filler material is supplied to the laser beam by means of a conveying gas, wherein the conveying gas in particular has a relative atomic mass of at least 4, in particular at least 14, and/or a specific volume flow rate of at least 3.21 (STP)/min per mm² of cross-sectional area. It has been found that the conveying gas having the above parameters provides sufficiently strong momentum and therefore a sufficiently high filler material velocity, in particular powder velocity, that the filler material can be guided to the laser beam without any significant influence by external factors, for example the gravity acting on the filler material, and thus in an optimal manner.

It can also be provided that the coating layer of the component is produced in the direction from the relative inside of the surface to the relative outside of the surface. In the case of a disk as the component, the coating or the movement of the laser beam point thus proceeds from the radial inside or the internal diameter to the radial outside or the external diameter. In this way, it is possible to use thermal expansion to generate tensile stresses in the component, especially the disk. Upon cooling, compressive stresses form in the coating layer that has been welded on. These are advantageous since compressive stresses counteract the progression of cracks in the coating layer that has been welded on.

Moreover, it can be provided that a laser beam axis of the laser beam is inclined at an angle of incidence in the range from greater than 0° to 35°, especially in the range from 5° to 30°, relative to the surface. For this purpose, a main axis of a processing head from which the laser beam is emitted can be correspondingly inclined with respect to the surface. Laser light reflected back by the component at the angle of incidence thus does not strike the processing head, but is deflected past it.

It is also possible that the intensity distribution of the laser beam is created at least approximately in the form of a so-called “flat top”. In comparison with a Gaussian laser output power distribution, it has been found that lower roughnesses are thus created in the coating layer. In particular, the intensity distribution can be approximately in the shape of a flat top with a region of lower intensity in the center (I_max (maximum intensity)≥I_core (intensity in the core)≥0). This opens up large process windows for the laser cladding process.

In another aspect of the present invention, a component has a surface that has been coated with a coating layer, wherein the coating layer has been produced by means of a laser cladding method according to embodiments of the invention.

The tracks partially overlapping one another along the track width can be seen here in the cross section of the component under microscopic examination, so that the component produced by means of the laser cladding method can be clearly distinguished from components, the coating layer of which has been produced by means of another method.

Features described herein in relation to the laser cladding method are likewise applicable in relation to the component and vice versa.

In another aspect of the present invention, a device is configured to execute a laser cladding method according to embodiments of the invention, wherein the device has at least one laser for generating the laser beam, and wherein the device has at least one filler material conveyor for conveying the at least one filler material at a distance from the surface of the component to the laser beam.

Features described herein in relation to the laser cladding method and the component are likewise applicable in relation to the device, and vice versa in each case.

In particular, the device can have a regulation and/or control unit, which is configured to regulate and/or control the laser cladding process such that at least two or at least three turns of the at least one coating track each overlap along a track width. A regulation and/or control program having corresponding instructions can be provided in the regulation and/or control unit for this purpose.

The at least one laser can preferably have a laser power output of more than 4 kW, in particular more than 12 kW, and up to 24 kW. This can, for example, be a laser having a wavelength of approximately 1 μm (fiber laser, disk laser), approximately 0.8 μm (diode laser), or 0.5 μm (green-converted). It is possible to use a laser light cable having 2-in-1 fibers, wherein a core diameter of 600 μm to 1000 μm or diameter ratios of 200 μm/700 μm and 300 μm/1000 μm can be implemented. It is also possible to use an adjusting device (wedge beam switch) to adjust the core-shell ratio of the 2-in-1 fibers. A processing head of the laser, for imaging of the fiber end of the 2-in-1 fibers into the region of a powder focus or onto the surfaces, can have a focus of approximately 1.4 mm to approximately 8 mm.

The at least one filler material conveyor can be designed as a powder conveyor and can have a powder nozzle to form a powder focus. The powder nozzle can, as has been described above, be embodied by means of injectors, in particular having multiple injectors as a multi-jet nozzle. Inert gas, such as argon or helium or a gas mixture thereof, can be used as the conveying gas, for example. It is also possible to feed a protective process gas to the process.

Furthermore, of course, other units can be provided in the devices, for example, the above-mentioned measuring device, a component receptacle, etc.

Further details and advantageous embodiments of the invention can be inferred from the following description, on the basis of which exemplary embodiments of the invention are described and explained in more detail.

In the description that follows and in the figures, the same reference signs are used in each case for identical or corresponding features.

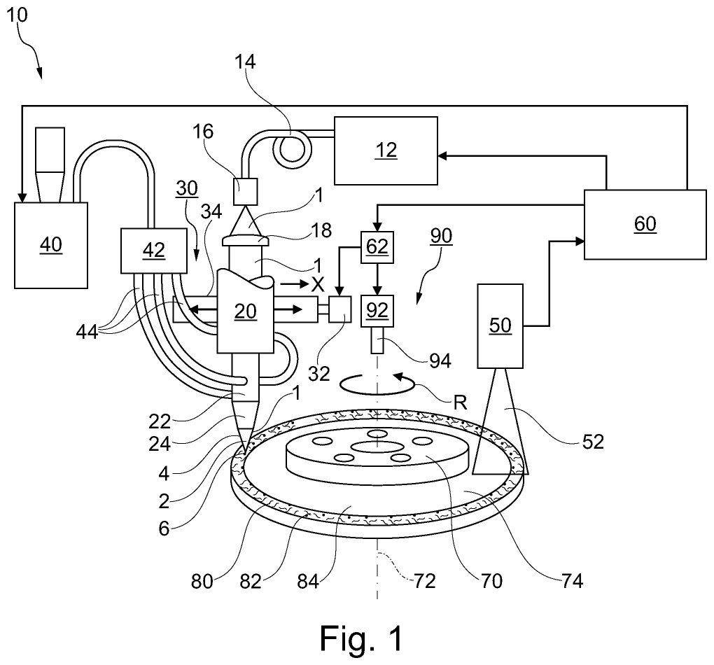

FIG. 1 shows, overall, a device 10 for laser cladding. The device 10 comprises a laser 12 for generating a laser beam 1. The laser beam 1 generated is fed to a light exit 16 via an optical waveguide cable 14. The laser beam 1 thus generated is then collimated in a collimation lens 18. Thereafter, the laser beam 1 passes through a movable processing head 20 (incidentally, the light exit 16 and the collimation lens 18 can alternatively also be arranged in the processing head 20 itself). A focusing lens (not shown) for focusing the laser beam 1 is arranged inside the processing head 20. After passing through the focusing lens, the laser beam 1 passes through a cylindrical section 22 and a funnel-shaped section 24 of the processing head 26, which are also used herein as a powder nozzle for a powdered filler material 2.

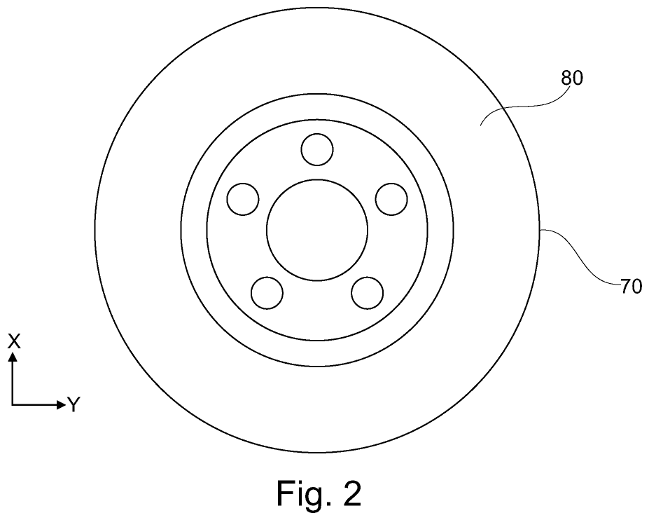

The entire assembly composed of light exit 16, collimation lens 18, and processing head 22 is arranged so as to be linearly movable by means of a feed unit 30 across a component 70 to be coated. To be exact, the feed unit 30 can be moved in the plane formed by an X coordinate and Y coordinate across the component 70 (see FIG. 2). By way of example, the feed unit 30 in the present context comprises a linear drive 34 and an electric motor 32 that drives the linear drive 34. Moreover, the device 10 comprises a rotation unit 90 which, in the present context, has a further electric motor 92 with a shaft 94 coupled thereto for rotating the component 70 mounted thereon. The component 70 is designed as rotationally symmetric here by way of example, in particular as a brake disk, and is rotated around its axis of rotation 72, which coincides with the shaft 94, in the direction of rotation R shown in the course of coating of the component 70 with a coating layer 80 which will be explained in more detail hereinafter.

The device 10 also comprises a filler material conveyor 40 for conveying powdered filler material 2. In the filler material conveyor 40, the powder is admixed with a gas, in particular an inert gas such as nitrogen or argon, in order to generate a powder gas stream 4 for conveying the powder. In a distributor component 42, the powder gas stream 4 is distributed into two or more, three by way of example in the present case, feed lines 44, in particular feed hoses, and then flows into the cylindrical section 22 of the processing head 20. The section 24 of the processing head 20 has a double wall, wherein the powder gas stream is conducted through the annular gap achieved thereby, such that the powder gas stream 4 flows through between the two walls. The laser beam 1 and the powder gas stream 4 therefore run coaxially through the sections 22 and 24. In the funnel-shaped section 24, the annular gap between the two walls narrows, such that the powder gas stream 4 departs through a nozzle-like outlet of the funnel-shaped section 24 that is formed thereby.

The device 10 also comprises a sensory measuring device 50. The measuring device 50 can be configured, for example, to execute the light section method, in order thus to generate a height profile of the surface 74. It is possible here, for example, to conduct a light section scan at 4 kHz. In particular, a height profile can be generated here along a projected light line 52 shown in schematic form.

Finally, the device 10 comprises a regulating device 60. This is used, on the one hand, to control the laser 12 and the filler material conveyor 40. In addition, it is used to actuate a control unit 62, which likewise forms part of the device 10 and is set up to actuate the electric motor 32 and the further electric motor 92. Furthermore, the regulating device 60 is configured to evaluate the measurement signals detected by the measuring device 50. The regulating device 60 can, for example, measure the height profile of the coating layer 80 and compare it to a limiting value for a previously defined maximum waviness of the coating layer 80. If the limiting value is exceeded, the regulating device 60 can intervene accordingly by way of regulatory measures.

FIG. 2 shows the component 70 in the form of a brake disk for a motor vehicle, wherein the surface 74 has the coating layer 80 that has been produced by the method described hereinafter. Such a coating layer 80 can also be created on the opposite surface 74 or side of the component 70.

Overall, the device 10 is configured to execute the method set out below:

The surface 74, which is circular ring-shaped in the present case, of the component 70 is coated by means of the device 10 by extreme high-speed laser application (EHLA). For this purpose, the component 70 is first set in rotation in that the shaft 94 is driven by the further electric motor 92.

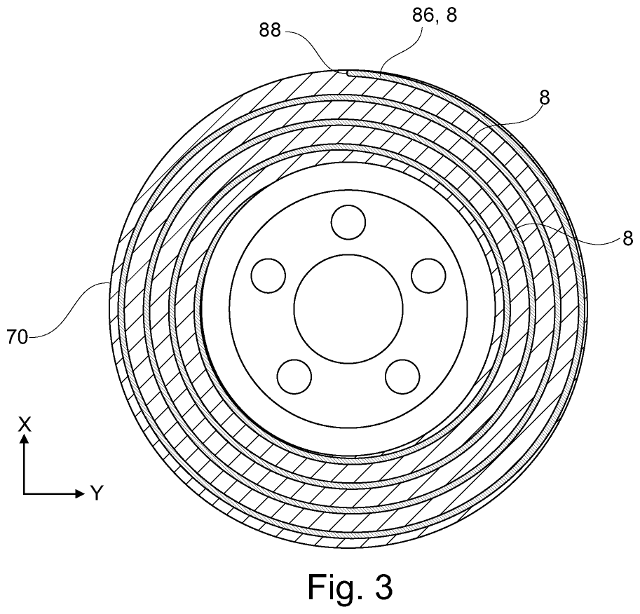

In addition, the laser beam 1 is generated and projected onto the surface 74, wherein the laser beam 1 is incident on the surface 74 at a point of incidence. A process zone 6 is thus created on the surface 74. In addition, a powder gas stream 4 is generated. After departing from the cylindrical section 24, the powdered filler material 2 in the powder gas stream 4, during its flight phase, meets the light pathway of the laser beam 1. As a result, the filler material 2 in the form of the powder particles is melted at least partly or completely before these particles reach the process zone 6 on the component 70. The filler material 2 is therefore preferably fed to the process zone 6 in completely molten form. The filler material 2 melted by heating by means of the laser beam 1 is therefore applied to the surface 74 of the component 70. At the same time, the component 70 is rotated around the axis of rotation 72 fast enough that the point of incidence of the laser beam 1 is moved along a predetermined processing trajectory 88 (see FIG. 3) on the surface 74 at a speed of at least 20 m/min along the surface 74, so that this can also be referred to as the above-mentioned high-speed laser application. As a result, the process zone 6 generated by means of the laser beam 1 is moved along the surface 74 by at least 20 m/min. At least one coating track 86 is thus generated along the processing trajectory 88 by means of the molten filler material 2, as will be explained in more detail hereinafter with reference to FIG. 3.

A coating layer 80 is gradually created here by the laser cladding process. As shown solely by way of example in FIG. 3, for this purpose, the laser beam 1 is gradually moved from radially outward to radially inward relative to the axis of rotation 72 by means of the linear drive 34, so that the point of incidence of the laser beam 1 is moved along the surface 74 in a spiral-shaped processing trajectory 88. At least one coating track 86 having multiple turns 8, which extend around one another or around a center point of the component 70, thus arises along the processing trajectory 88. The coating track 86 or the turns 8 is or are preferably continuously created, thus without a processing stop and furthermore essentially without a gap between them, in particular contrary to FIG. 3, which gap only serves for better comprehension in FIG. 3. Similarly, the process zone 6 is therefore guided in a spiral from radially outward to radially inward (or vice versa) to create the coating layer 80. As is apparent in FIG. 1, the surface 74 comprises a coated radially outer section 82 and an uncoated radially inner section 84.

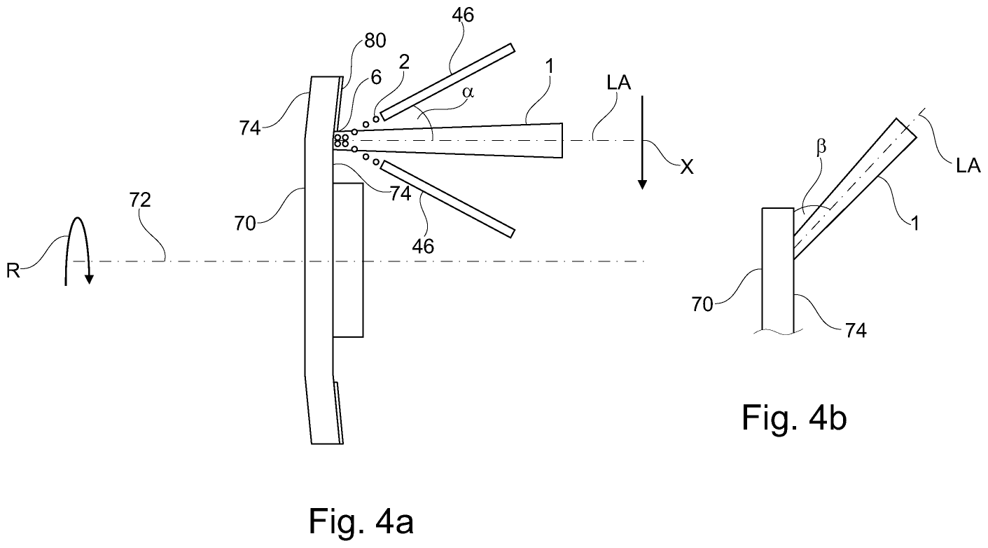

FIG. 4a shows the laser cladding method for the component 70 similarly to FIG. 1 in a schematic cross-sectional view. Unlike in FIG. 1, no processing head 20 is used, as described in relation to FIG. 1. Instead, two or more injectors 46 are used here, of which only two are shown here by way of example, by means of which the filler material 2 is fed directly to the laser beam 1, in particular as a powder gas stream 4. The injectors 46 are shown here by way of example as tubes, in particular carbide tubes. They may each be connected to the distributor component 42 by means of one, two, or more feed lines 44. It is also possible that each injector 46 has a separate distributor component 42, wherein the distributor components 42 can in turn be connected to the filler material conveyor 40. As can also be seen in FIG. 4a, the laser beam 1 with its laser beam axis LA is moved in the present case by way of example in X direction as the feed direction, which means that its point of incidence is also moved in that direction. In the case of rotation R of the component 70, this takes place around the axis of rotation 72.

In FIG. 4a, in addition, an exit angle α of the injectors 46, with respect to a perpendicular to the respective surface 74, which coincides here by way of example with the longitudinal axis LA of the laser beams 1, is less than 60°. It has been found that a resulting surface waviness of the coating layers 80 that have been welded on thereby is thus minor.

FIG. 4b shows a modification of the beam guidance of the laser beam 1, in which the laser beam axis LA of the laser beam 1 is at an advantageous angle of incidence β with respect to the surface 70, such that the laser beam 1 is incident on the surface 70 with its point of incidence at the angle of incidence B. The angle of incidence β here is 35° by way of example. The angle of incidence β can in particular be achieved by appropriate arrangement of the processing head 20 relative to the surface 70, wherein the powder gas stream 4 can be conducted within the processing head 20, as shown in FIG. 1, or can be conducted outside the processing head 20, so that only the laser beam 1 is guided within and exits from the processing head 20. Advantageously, a laser beam 1 incident on the surface 74 at the angle of incidence β cannot be reflected back to the processing head 20 as laser light, but is deflected past it. The waviness of the coating layer 80 is also further reduced.

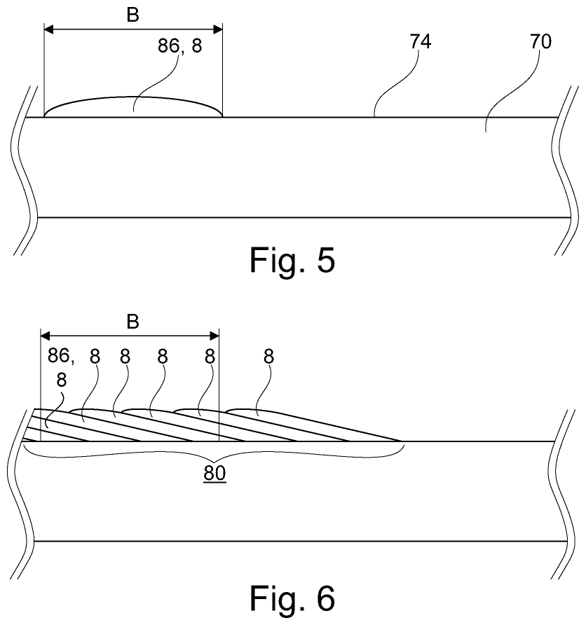

FIG. 5 shows a cross-sectional view through a part of the component 70 during the execution of a conventional laser cladding method. A coating track 86 having the track width B is applied to the surface 74. In the laser cladding method known from the prior art, a next turn 8 of the coating track 86 in FIG. 5 (not shown) will be applied toward the right or radially inward from the component 70, adjacent to the turn 8 shown, in relation to FIG. 5. This results in a high level of waviness of the coating layer 80 thus created, in particular at high laser output powers of the laser beam 1. This waviness can be reduced by later grinding of the coating layer 80, but the usable coating layer 80 is thus also decreased.

FIG. 6 shows a cross-sectional view through a part of the component 70 during the execution of a laser cladding method according to an exemplary embodiment of the invention. Multiple turns 8 are applied adjacent to one another and partially overlapping with one another at the same time here along the track width B of a coating track 86. In the present case, for example, approximately four turns 8 are located one on top of another in a track width B. The number of the turns 8 partially overlapping one another per track width B is determined here in the top view of the individual turns 8 per track width B. Therefore, only the part of the turns 8 visible at the surface is crucial.

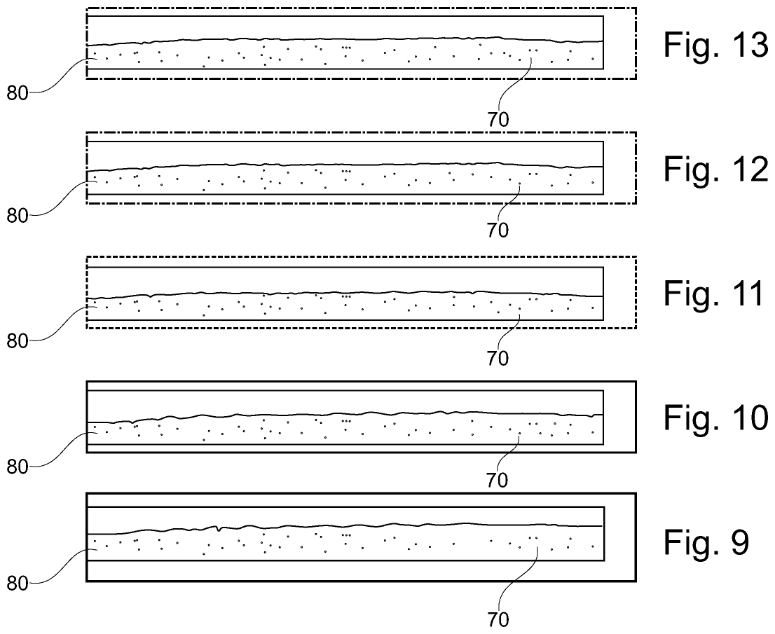

The surface waviness of the coating layer 80 is significantly reduced by such an overlap, as will be explained in more detail later with reference to FIGS. 9 to 13. Post-grinding with corresponding removal of the usable coating layer 80 can advantageously thus be avoided.

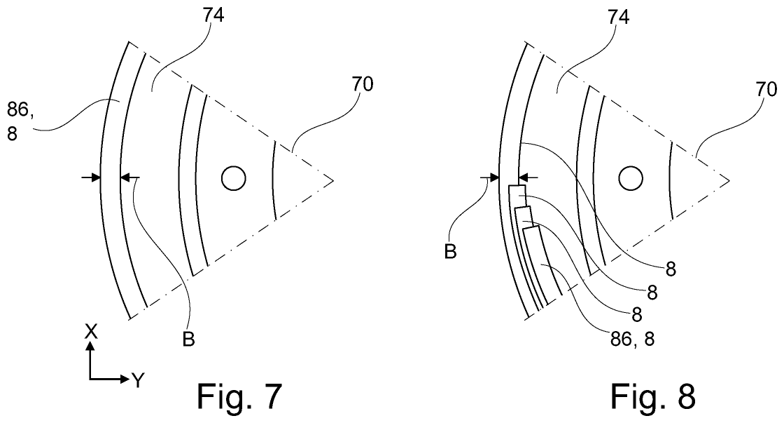

FIG. 7 shows the prior art once again in a top view of a part of the component 70. The turns 8 of the coating track 86 are applied adjacent to one another here with their track width B defined by the focus diameter of the focusing lens of the laser beam 1, wherein only one turn 8 is shown here.

In contrast, FIG. 8 shows the overlap of multiple turns 8 of a coating track 86 in the region of a track width B, as is provided in a laser cladding method according to an exemplary embodiment of the invention.

FIGS. 9 to 13 show microsections through components 70 having coating layers 80. The microsections differ in the number of turns 8, (at least partially) partially overlapping over a track width B, of a coating track 86.

FIG. 9 shows the result of a coating layer 80 with partial overlap of 3.3 turns 8 located adjacent to one another along a track width B and FIG. 10 shows the result of a coating layer 80 with a respective partial overlap of 3.7 turns 8 located adjacent to one another along a track width B. As can be seen, with this parameter selection a comparatively high waviness of the coating layer 80 in relation to FIGS. 11 to 13 is still present.

FIG. 11 shows the result of a coating layer 80 with a partial overlap of 4.1 turns 8 adjacent to one another along a track width B. FIG. 12 shows the result of a coating layer 80 with a partial overlap of 4.7 turns 8 adjacent to one another along a track width B. And FIG. 13 shows the result of a coating layer 80 with a partial overlap of 5.5 turns 8 adjacent to one another along a track width B. As can be seen, with this parameter selection only a comparatively minor waviness of the coating layer 80 is still present.

Accordingly, it has been shown that with a partial overlap from approximately four turns 8 adjacent to one another along a track width B, a typically sufficiently minor waviness of the coating layer 80 results that post-grinding is no longer necessary or only still requires a very minor removal of the usable coating layer 80 in order to achieve an optimum surface finish.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A laser cladding method for producing a coating layer on a surface of a component comprising:
applying a filler material along a helical or spiral-shaped processing trajectory on the surface of the component, and
heating the filler material and the component along the processing trajectory by using a laser beam, so that when the filler material strikes the surface, least one coating track is created on the surface having a specified track width, wherein at least two turns of the at least one coating track at least partially overlap with one another along the track width.

2. The laser cladding method as claimed in claim 1, wherein at least three turns of the at least one coating track at least partially overlap with one another along the track width.

3. The laser cladding method as claimed in claim 1, wherein at least four turns of the at least one coating track at least partially overlap with one another along the track width.

4. The laser cladding method as claimed in claim 1, wherein the at least two turns overlap with one another by at least 20% of the track width.

5. The laser cladding method as claimed in claim 4, wherein the at least two turns overlap with one another by at least 40% of the track width.

6. The laser cladding method as claimed in claim 1, wherein a number of turns at least partially overlapping with one another along the track width is varied during the production of the coating layer.

7. The laser cladding method as claimed in claim 1, wherein further turns of the at least one coating track are created above the at least two turns in a starting and/or end region of the processing trajectory over the track width.

8. The laser cladding method as claimed in claim 1, wherein a height profile of the surface coated using the at least one coating track) is generated by a measuring device.

9. The laser cladding method as claimed in claim 8, wherein a total thickness and/or a waviness of the at least one coating track on the surface is determined based on the height profile and is compared to a specified limiting value.

10. The laser cladding method as claimed in claim 1, wherein a point of incidence of the laser beam on the surface is moved along the surface at a relative speed of at least 20 m/min along the processing trajectory.

11. The laser cladding method as claimed in claim 1, wherein the component is configured as rotationally symmetrical, and is rotated around an axis of rotation during the production of the coating layer.

12. The laser cladding method as claimed in claim 1, wherein the at least one filler material is in a powder form before being melted by the laser beam.

13. The laser cladding method as claimed in claim 1, wherein the at least one filler material is fed to the laser beam via a conveying gas, wherein the conveying gas has a relative atomic mass of at least 4 and/or a specific volume flow rate of at least 3.21 (STP)/min per mm² of cross-sectional area.

14. The laser cladding method as claimed in claim 1, wherein the coating layer of the component is produced in a direction from a relative inside of the surface to a relative outside of the surface.

15. The laser cladding method as claimed in claim 1, wherein a laser beam axis of the laser beam is inclined at an angle of incidence in the range from greater than 0° to 35° relative to the surface.

16. A component having at least one surface that is coated with a coating layer, wherein the coating layer is produced by a laser cladding method as claimed in claim 1.

17. A device for executing a laser cladding method as claimed in claim 1, wherein the device comprises at least one laser for generation of the laser beam, and at least one filler material conveyor for conveying the at least one filler material to the laser beam.
